(19) United States
(12) Patent Application Publication
(10) Pub. No.: US 2008/0168868 A1
(43) Pub. Date: Jul. 17, 2008

(54) ASSISTANT CONNECTOR FOR A TOOL

(76) Inventor: Min-Li Yang, Chang Hua City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/622,661

(22) Filed: Jan. 12, 2007

(51) Int. Cl. F16D 3/16; F16D 3/18; F16D 3/20; B25B 23/00

(52) U.S. Cl. 81/177.75

(57) ABSTRACT

An assistant connector for a tool comprises a connecting member, a transmission member and a positioning sleeve. The connecting member is provided with a first engaging sleeve on one end thereof, an engaging section on the other end thereof and a pivot head extending from the engaging section. The pivot head is inserted in one end of a pivot groove of the transmission member provided with a second engaging sleeve on the other end thereof, for forming a freely rotary relationship. In the periphery of the transmission member are formed with a first and a second annular grooves for engaging with a C-shaped ring, respectively. The positioning sleeve formed with a first and a second annular positioning grooves in the inner surface thereof mounts on the transmission member. Thereby, it can meet the requirements of a straight-pole operational mode and a rotary operational mode, achieving simple and convenient operation.

### BACKGROUND OF THE INVENTION

1. Field of the Invention

The present invention relates to a tool assistant instrument, and more particularly to an assistant connector for a tool capable of being transformed into a straight-pole mode or a rotary mode according to use requirements.

2. Description of the Prior Art

Conventional screwdrivers are all in straight-pole operational mode, however in some special working spaces, the straight-pole operational mode cannot be applied, or even a problem causing unable to work will be derived. It is the shortcoming of the conventional tools to be improved.

In order to meet the operational requirements in special working spaces, a rotatable assistant connector (as shown in FIGS. 1-3) has been developed, namely a conventional assistant connector for a tool, which comprises a positioning sleeve 20 mounted on a tool connecting rod 10, the front end of the tool connecting rod 10 provided with a spherical head 101 formed with a pivot hole 1011 flared toward both ends is pivotally coupled to an engaging member 30 by a pin 102. A front annular groove 103 and a back annular groove 104 are formed in the outer surface of the 10 and located behind the spherical head 101 for accommodation of a C-shaped ring 105,106. Another annular groove 201 is formed in the inner surface of the positioning sleeve 20. As shown in FIG. 2, when the C-shaped ring 105 of the annular groove 103 of the connecting rod 10 is engaged with the annular groove 201 of the positioning sleeve 20, the positioning sleeve 20 thus achieving a normal straight-pole operational mode. As shown in FIG. 3, the positioning sleeve 20 is pushed to move backward until it is stopped by the C-shaped ring 106 of the back annular groove 104 of the connecting rod 10, so that the positioning sleeve 20 is disengaged from the engaging member 30, thus achieving a rotary operational mode.

The afore-mentioned conventional assistant connector for a tool has the following shortcomings:

1. The front end of the connecting rod 10 formed with the spherical head 101 defined with the pivot hole 1011 is pivotally coupled to the engaging member 30 by the pin 102, even so the engaging member can freely sway, but the connection relationship between the spherical head 101 and the engaging member 30 will result in that the engaging member 30 cannot be smoothly rotated by the connecting rod 10 and that the engaging member 30 will rotate with the connecting rod 10 in use, so that the engaging member 30 cannot be designed with a holding portion. Consequently, some different inconveniences will occur in use.

2. The pivot hole 1011 flared toward both ends thereof needs to be formed in the spherical head 101 of the front end of the connecting rod 10. The pivot hole is hard to machining because of its special shape, and consequently the machining cost is relatively high.

3. The torque force of the connecting rod 10 for rotating the engaging member 30 is focused on the spherical head 101 and the pin 102. Consequently, if the diameter of the pin 102 is too small, the pin 102 is likely to rupture; if the diameter of the pin 102 is too large, the pivot hole 1011 of the spherical head 101 will correspondingly be larger, thus reducing the structural strength of the spherical head 101, and consequently, the spherical head 101 is likely to be deformed in use.

Another conventional assistant connector for a tool (as shown in FIG. 4-6) mainly comprises a connecting member 40, one end of the connecting member 40 is provided with an inserting rod 401, and the other end of the connecting member 40 is provided with a coupling sleeve 402. A coupling groove 4021 and a pivot hole 4022 are formed in an end surface of the coupling sleeve 402, and the pivot hole 4022 embedded with a magnet 4023 in the bottom thereof is provided for the insertion of a pivot head 501 of a transmission member 50, furthermore, the pivot head 501 can move a distance in the pivot hole 4022, in addition, one end of the transmission member 50 where is provided the pivot head 501 is formed with an engaging section 502, the other end of the transmission member 50 is arranged with an engaging sleeve 503. A rotatable sleeve 60 is rotatably mounted on the transmission member 50. As shown in FIG. 5, the pivot head 501 of the transmission member 50 is attracted by the magnet 4023 of the coupling sleeve 402 of the connecting member 40, and the coupling groove 4021 of the coupling sleeve 402 of the connecting member 40 is engaged with the engaging section 502 of the transmission member 50 so as to maintain the engaging state of the coupling sleeve 402 relative to the transmission member 50, thus achieving the normal straight-pole operational mode. As shown in FIG. 6, pushing the transmission member 50 can make the pivot head 501 of the transmission member 50 disengage from the magnet 4023, and at the same time the engaging section 502 of the transmission member 50 disengages from the coupling groove 4021 of the coupling sleeve 402, thus achieving the rotary operational mode.

The afore-mentioned another conventional assistant connector for a tool has the following shortcomings:

1. When it is used in a rotary operation mode, the pivot head 501 of the transmission member 50 is likely to be attracted by the magnetic force of the magnet 4023 to move inward even in the case of a small impact, and as result, the coupling groove 4021 of the coupling sleeve 402 of the connecting member 40 will engage with the engaging section 502 of the transmission member 50. Consequently, it will return to the straight-pole mode accidentally, causing inconvenience of use.

2. The positioning function is achieved by the magnetic force of the magnet 4023, so not only the machining cost is relatively high, but also after a long time of use, the positioning effect and the magnetic force will gradually disappear for the demagnetization of magnet 4023.

3. The inserting rod 401 formed on one end of the connecting member 40 is provided for connecting with a tool, so it can be only applied to a normal hand tool, an electric tool and a pneumatic tool, but is unsuitable for use in a special tool.

The present invention has arisen to mitigate and/or obviate the afore-described disadvantages.

### SUMMARY OF THE INVENTION

An assistant connector for a tool of the present invention mainly comprises a connecting member, the connecting member is provided with a first engaging sleeve on one end thereof, an engaging section on the other end thereof and a pivot head extending from the engaging section. The pivot head is inserted in a pivot groove on one end of the transmission member disposed with a second engaging sleeve on the other end thereof to form a freely rotary relationship, namely the connecting member is rotatably connected to the transmission member. A positioning sleeve mounts on the transmission member. A first annular groove and a second annular groove are formed in the outer predetermined position of the transmission member, the two annular grooves are respectively engaged with a C-shaped ring, and the inner surface predetermined position of the positioning sleeve is formed with a first annular positioning groove and a second ring positioning groove. Thereby, the positioning sleeve can be pushed to move toward the connecting member until the second annular positioning groove in the inner surface of the positioning sleeve is engaged with the C-shaped ring of the first annular groove of the transmission member, thus the engaging state of the positioning sleeve relative to the connecting member is maintained, forming a normal straight-pole operational mode. In addition, the positioning sleeve can be pushed to move toward the reverse direction until the first annular positioning groove in the inner surface of the positioning sleeve is engaged with the C-shaped ring of the first annular groove of the transmission member, thus the positioning sleeve will disengage from the connecting member, forming a rotary operational mode.

The primary objective of the present invention is that the pivot head of the connecting member is inserted in the pivot groove of the transmission member, then that holding the positioning sleeve can serve as a firm support in use. Consequently, no matter in the straight-pole mode or in the rotary operational mode, the transmission member can be smoothly driven to rotate by the connecting member equally, and the positioning sleeve is positioned by engaging the two positioning grooves with the C-shaped ring of the transmission member, as a result, preventing returning to the straight-pole operational mode casually when in the rotary operational mode. Consequently, the convenience and the practicability of use are improved.

The second objective of the present invention is that no special machining is needed, machining cost is relatively low and the positioning effect of the positioning sleeve is durable.

The third objective of the present invention is that the structure strength is fine, no deformation is likely to occur and it can be applied to a hand tool, an electric tool and a pneumatic tool at the same time. So its applicability is quite fine.

### BRIEF DESCRIPTION OF THE DRAWINGS

FIG. 1 is an exploded view of a conventional assistant connector for a tool;

FIG. 2 is a cross sectional view of the conventional assistant connector for a tool in positioning state;

FIG. 3 is a cross sectional view of the conventional assistant connector for a tool in releasing state;

FIG. 4 an exploded view of another conventional assistant connector for a tool;

FIG. 5 is a cross sectional view of another conventional assistant connector for a tool in positioning state;

FIG. 6 is a cross sectional view of another conventional assistant connector for a tool in releasing state;

FIG. 7 is an exploded view of an assistant connector for a tool in accordance with the present invention;

FIG. 8 is a perspective view of the assistant connector for a tool in accordance with the present invention;

FIG. 9 is a cross sectional view of the assistant connector for a tool in accordance with the present invention in positioning state;

FIG. 10 shows a releasing action of the assistant connector for a tool in accordance with the present invention;

FIG. 11 is a cross sectional view of the assistant connector for a tool in accordance with the present invention in releasing state;

FIG. 12 shows that the assistant connector for a tool in accordance with the present invention is connected with an electric tool; and

FIG. 13 shows that the assistant connector for a tool in accordance with the present invention is connected with a special hand tool.

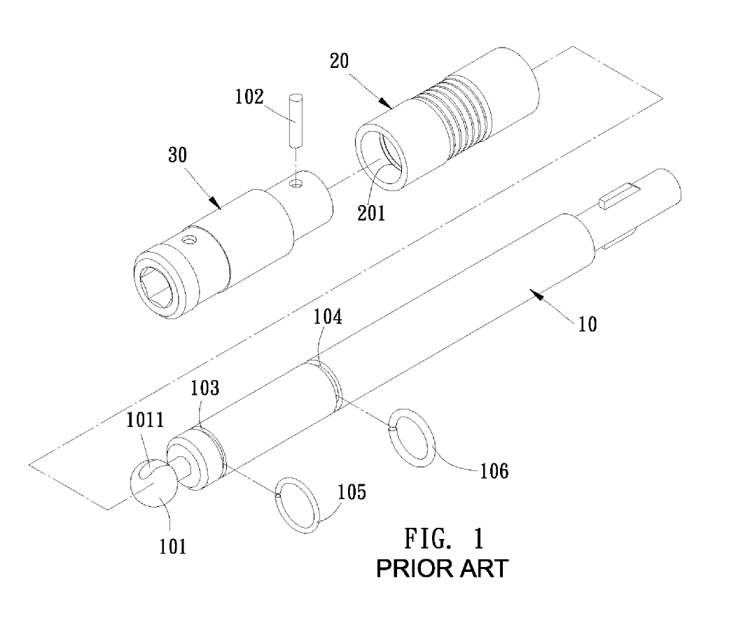

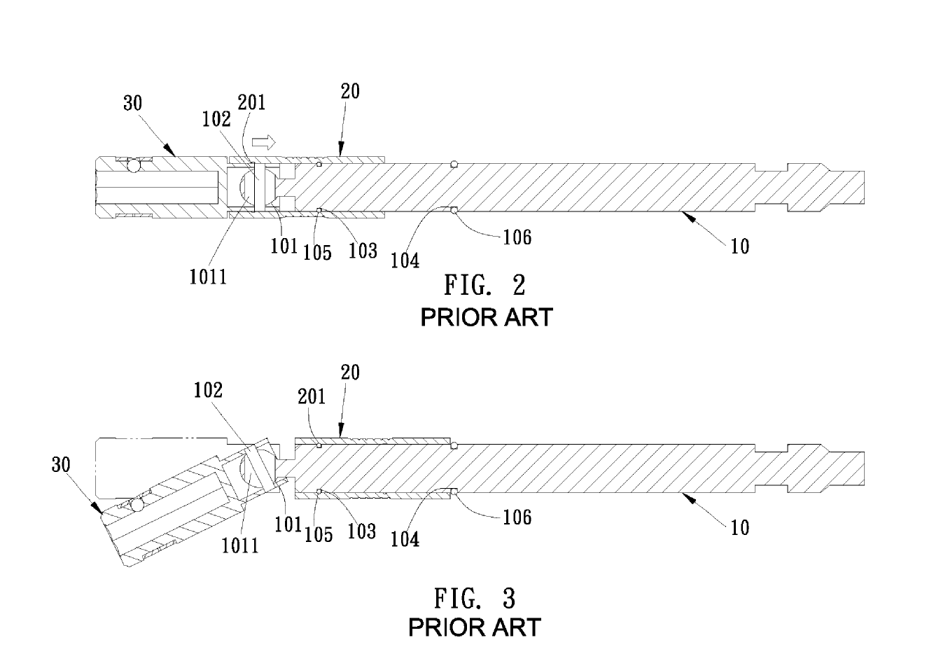

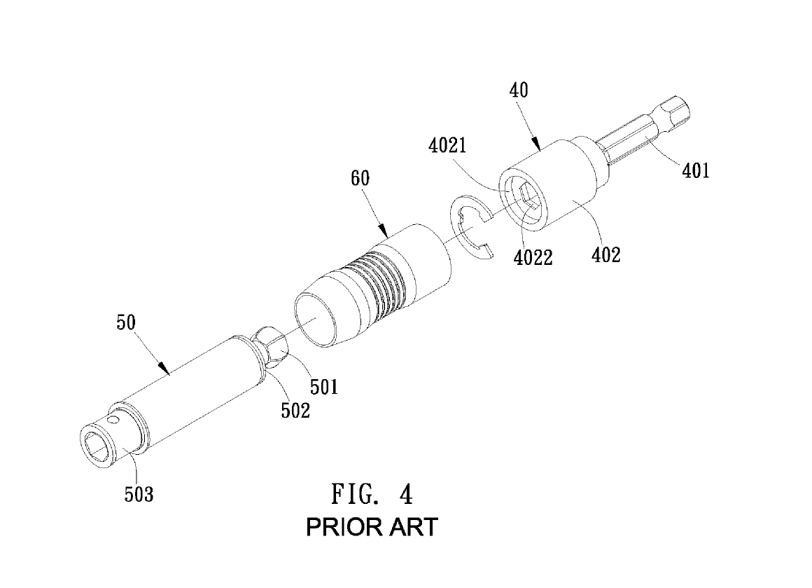

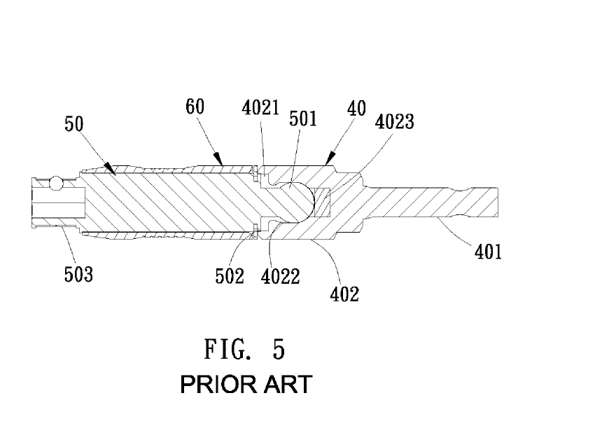

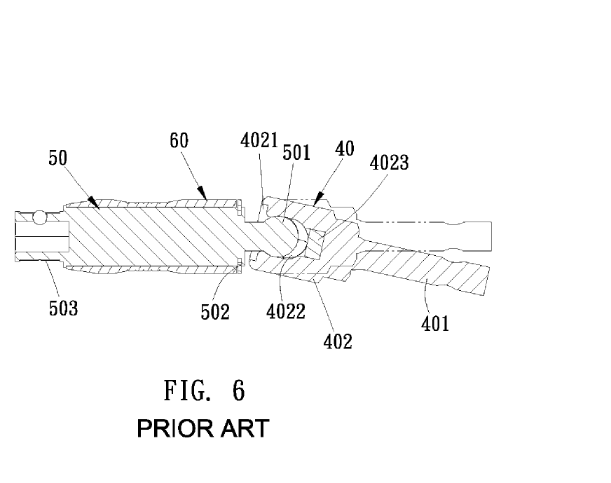

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

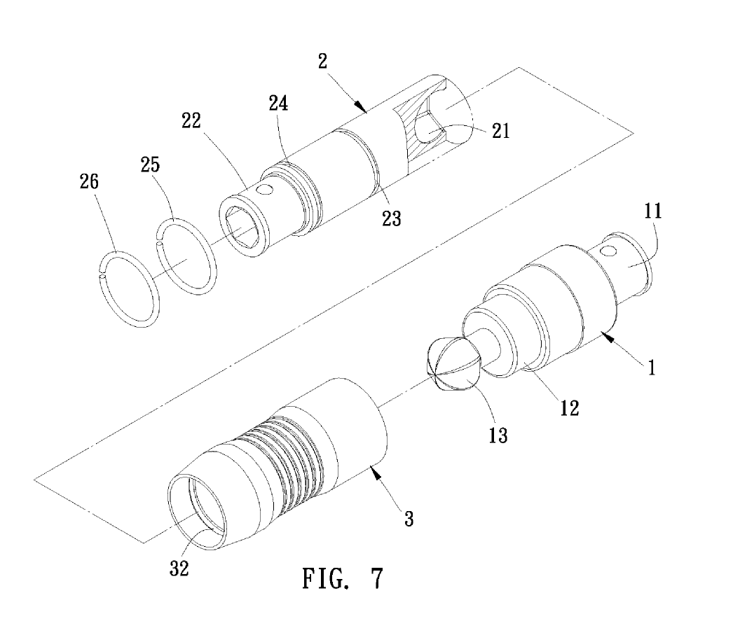

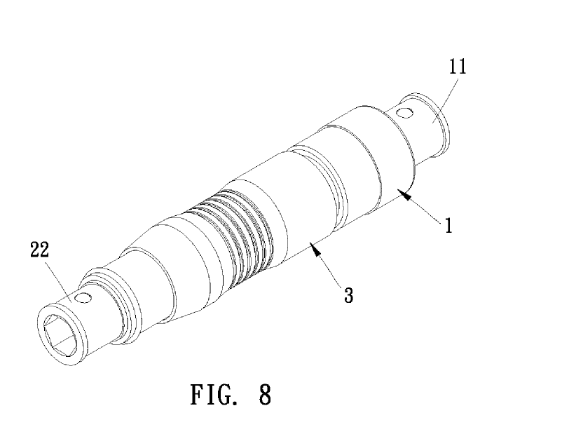

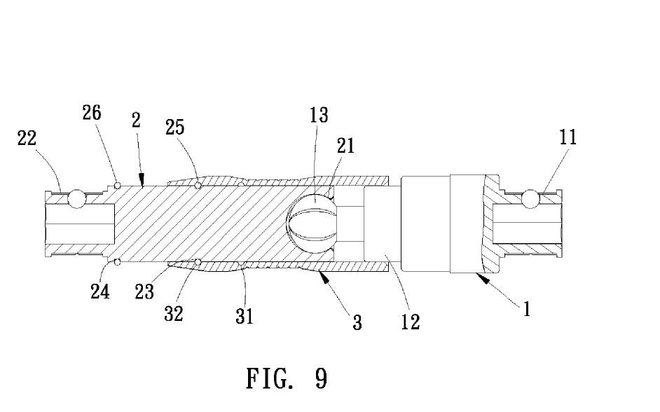

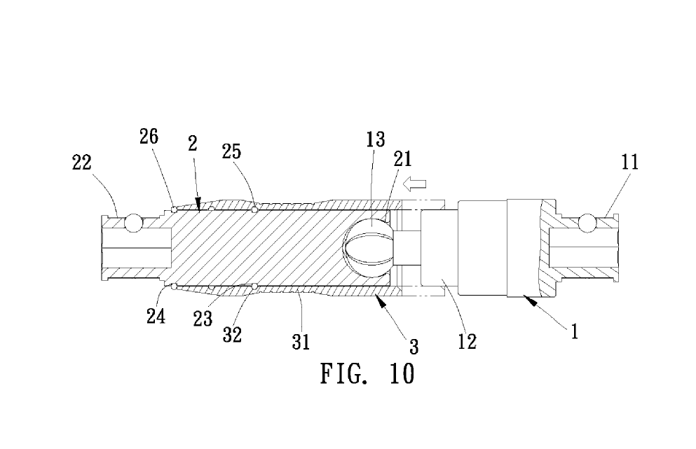

Referring to FIGS. 7-9, an assistant connector for a tool of the preferred embodiment in accordance with the present invention comprises a connecting member 1, a transmission member 2 and a positioning sleeve 3. One end of the connecting member 1 is provided with a first engaging sleeve 11, and the other end of the connecting member 1 is provided with an engaging section 12 and a hexagonal spherical pivot head 13 extending from the engaging section 12. One end of the transmission member 2 is formed with a hexagonal spherical pivot groove 21, and the other end of the transmission member 2 is formed with a second engaging sleeve 22. A first annular groove 23 and a second annular groove 24 are formed at predetermined positions on the outer surface of the transmission member 2 and located near the middle portion of transmission member 2 and the second engaging sleeve 22, respectively. In the first annular groove 23 and the second annular groove 24 are respectively received a C-shaped ring 25, 26. In the inner surface the positioning sleeve 3 are formed a first annular positioning groove 31 and a second annular positioning groove 32, and both of the first ring positioning groove 31 and the second annular positioning groove 32 are arc-shaped in cross section.

Furthermore, the pivot head 13 of the connecting member 1 is inserted in the pivot groove 21 of the transmission member 2, so that the connecting member 1 is rotatably connected to the transmission member 2. The positioning sleeve 3 is mounted on the periphery of the transmission member 2 and positioned against the C-shaped ring 26 of the second annular groove 24 of the transmission member 2, thus composing the tool assistant connector of the preferred embodiment in accordance with the present invention.

Thereby, the positioning sleeve 3 can be pushed to move toward the connecting member 1 until the second annular positioning groove 32 of the positioning sleeve 3 is engaged with the C-shaped ring 25 of the first annular groove 23 of the transmission member 2, so that the engaging section 12 of the connecting member 1 is engaged with one end of the positioning sleeve 3, and as a result, the connecting member 1 and the positioning sleeve 3 are unable to rotate relative to each other, forming a normal straight-pole operational mode.

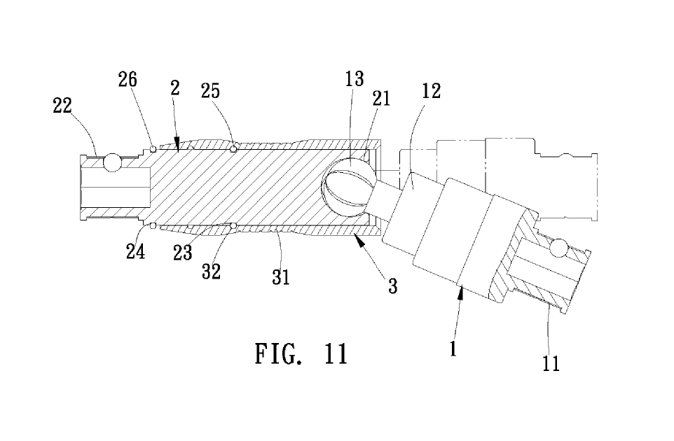

Referring to FIGS. 10-11, by pushing the positioning sleeve 3 to move toward the reverse direction, with the contractive elasticity of the C-shaped ring 25, the second annular positioning groove 32 in the inner surface of the positioning sleeve 3 will disengage from the C-shaped ring 25 of the first annular groove 23 of the transmission member 2, and the first annular positioning groove 31 in the inner surface of the positioning sleeve 3 will be engaged with the C-shaped ring 25 of the first annular groove 23 of the transmission member 2 again. At this time the positioning sleeve 3 disengages from the engaging section 12 of the connecting member 1, consequently, the positioning sleeve 3 is disconnected from the connecting member 1. So that the connecting member 1 can freely sway relative to the positioning sleeve 3, achieving rotary operational mode.

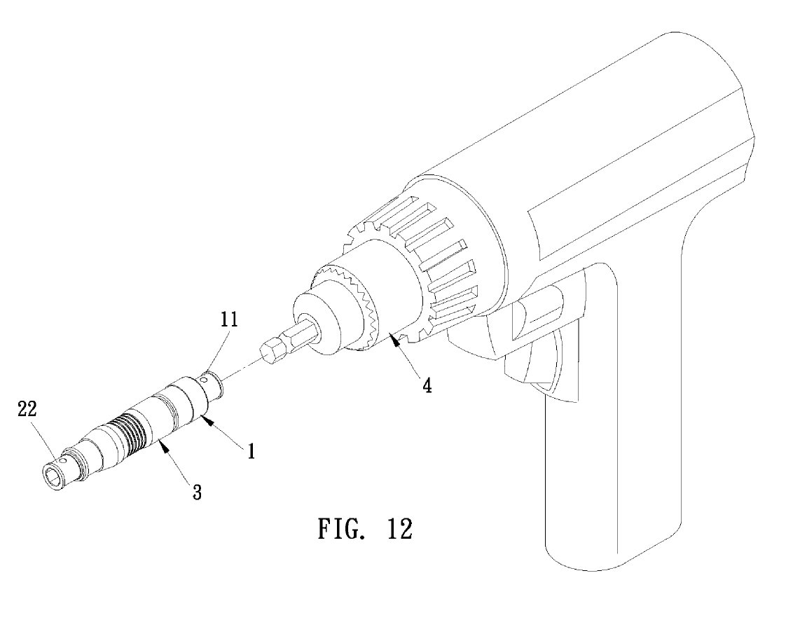

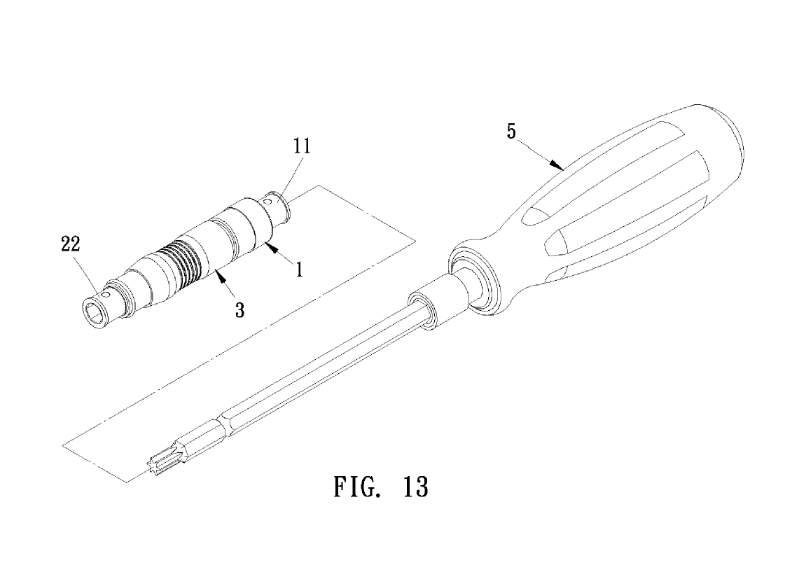

Referring to FIG. 12 and FIG. 13, the first engaging sleeve 11 of the connecting member 1 is provided for insertion of a connecting rod to be connected with an electric tool 4, a hand tool or a pneumatic tool, and the second engaging sleeve 22 of the transmission member 2 is used to connect with a tool head. Consequently, the positioning sleeve 3 is held by user to carry out straight-pole or rotary operation. In addition, the first engaging sleeve 11 of the connecting member 1 can be directly connected with a rod of a special hand tool 5, and the second annular positioning groove 32 of the transmission member 2 can be connected with a tool head, the positioning sleeve 3 is held by user to carry out straight-pole or rotary operation. So it is quite convenient.

With the above-mentioned preferred embodiment, the present invention has the following benefits:

1. The pivot head 13 of the connecting member 1 is inserted in the pivot groove 21 of the transmission member 2 to form the freely rotary relationship, namely the connecting member 1 is rotatably connected to the transmission member. That holding the positioning sleeve 3 can be served as firm support in use, so that no matter in the rotary operational mode or in the straight-pole operational mode, the transmission member 2 can be smoothly driven to rotate equally by the connecting member 1, and that the positioning sleeve 3 is located respectively by engaging the two positioning grooves 31, 32 with the C-shaped ring 25 of the first annular groove 23 of the transmission member 2. Thus it is firm to prevent the rotary operational mode from being transformed to straight-pole operational mode casually, thus improving the convenience and the practicality of the use.

2. Special machining is not needed, so the machining cost is relatively low. Furthermore, the positioning function between the positioning sleeve 3 and the transmission member 2 will not gradually disappear, after a long time of use.

3. The structure strength is fine and is less likely to deform. The service life is long. Furthermore, it can be applied to the hand tool 4, the electric tool 5 and the pneumatic tool at the same time. So its applicability is quite fine.

While we have shown and described various embodiments in accordance with the present invention, it is clear to those skilled in the art that further embodiments may be made without departing from the scope of the present invention.

What is claimed is:

1. An assistant connector for a tool comprising:
a connecting member including a first engaging sleeve for connection with a tool formed on one end thereof, an engaging section formed on the other end thereof, and a pivot head extending from the engaging section of the connecting member;
a transmission member including a pivot groove formed at one end thereof for the insertion of the pivot head, the pivot head being rotatably connected to the transmission member, a second engaging sleeve disposed at the other end of the transmission member for connecting with a tool head, a first annular groove and a second annular groove formed in periphery of the transmission member for accommodation of a C-shaped ring respectively; and
a positioning sleeve movably mounted on the transmission member, in an inner surface of the positioning sleeve being formed a first annular positioning groove and a second annular positioning groove, the positioning sleeve is provided for holding by user and is selectively engaged with or disengaged from the engaging section of the connecting member according to requirements, meeting the various operational requirements of straight-pole mode or rotary mode.

2. The assistant connector for a tool as claimed in claim 1, wherein, the first annular groove in the periphery of the transmission member is formed near a middle portion of the transmission member, and the second annular groove is formed near the second engaging sleeve.

3. The assistant connector for a tool as claimed in claim 1, wherein, both the first annular positioning groove and the second annular positioning groove in the inner surface of the positioning sleeve are arc-shaped in cross section.
